(19) United States
(12) Patent Application Publication
(10) Pub. No.: US 2025/0285852 A1
(43) Pub. Date: Sep. 11, 2025

(54) Parallel PTR Reactor

(71) Applicant: DH Technologies Development Pte. Ltd., Singapore (SG)

(72) Inventors: Pavel RYUMIN, Toronto (CA); Takashi BABA, Richmond Hill (CA)

(73) Assignee: DH Technologies Development Pte. Ltd., Singapore (SG)

(21) Appl. No.: 18/859,757

(22) PCT Filed: Apr. 26, 2023
(86) PCT No.: PCT/IB2023/054301

§ 371 Date: Oct. 24, 2024

Related U.S. Application Data
(60) Provisional application No. 63/334,779, filed on Apr. 26, 2022.

(51) Int. Cl. H01J 49/00; H01J 49/42

(52) U.S. Cl. CPC H01J 49/0072; H01J 49/422

(57) ABSTRACT

In one aspect, a mass spectrometer is disclosed, which includes an ion source configured to receive a sample and ionize at least one analyte in the sample to generate a plurality of ions of that analyte, at least a first ion routing device having a first inlet for receiving at least a portion of the plurality of the analyte ions and at least a first and a second outlet through which a first and a second portion of the received analyte ions can exit the ion-routing device, respectively, and at least two charge reduction devices one of which is coupled via a first inlet thereof to the first outlet and the other is coupled via an inlet thereof to the second outlet of the ion routing device to receive the first and second portions of the ions exiting the ion routing device.

### RELATED APPLICATIONS

This application claims priority to U.S. provisional application No. 63/334,779 filed on Apr. 26, 2022, entitled “Parallel PTR Reactor” which is incorporated herein by reference in its entirety.

### TECHNICAL FIELD

The present disclosure is generally directed to methods and systems for performing mass spectrometry, and more particularly, to such methods and systems that employ a plurality of parallel charge-reduction devices for efficient separation of complex mixtures.

### BACKGROUND

Mass spectrometry (MS) is an analytical technique for characterizing molecular structure of test substances with both quantitative and qualitative applications. For example, MS can be used to identify unknown compounds, to determine the isotopic composition of elements in a molecule, and to determine the structure of a particular compound by observing its fragmentation, as well as to quantify the amount of a particular compound in a sample.

Proton transfer reaction (PTR) is becoming an important tool for separation of complex mixtures of molecular ions in gas phase. For example, by reducing the charge state of a plurality of highly charged ions having similar masses, a better separation of ions based on their m/z ratios can be achieved. Unfortunately, PTR can typically exhibit inherently slow reaction times, which renders the coupling of the PTR with other fast analytical techniques difficult. Another common drawback of PTR is signal dilution among multiple end channels.

### SUMMARY

In one aspect, a mass spectrometer is disclosed, which includes an ion source configured to receive a sample and ionize at least one analyte in the sample to generate a plurality of analyte ions, at least a first ion routing device having a first inlet for receiving at least a portion of the plurality of the analyte ions and at least a first and a second outlet through which a first and a second portion of the received analyte ions can exit the ion-routing device, respectively, and at least two charge reduction devices one of which is coupled via a first inlet thereof to the first outlet and the other is coupled via an inlet thereof to the second outlet of the ion routing device to receive the first and second portions of the ions exiting the ion routing device.

Each of the charge reduction devices can include a second inlet for receiving a plurality of reagent ions for reacting with the analyte ions received by that charge reduction device to reduce a charge state of the analyte ions, thereby generating a plurality of charge reduced ions. In some embodiments, the charge-reduced ions generated in a charge reduction device can be received by a respective ion storage device in which the charge reduced ions can be stored for subsequent release to downstream components of the mass spectrometer, e.g., an ion fragmentation device.

The charge reduction device can be, for example, a proton transfer reaction (PTR) device. Further, in embodiments, an ion routing device employed in the practice of the present teachings can be a branched RF ion trap. In embodiments in which the ion routing devices are implemented as branched RF ion traps, one or more RF voltage sources can be employed for applying RF voltage(s) thereto. By way of example, the applied RF voltages can have a frequency in a range of about 100 kHz to about 10 MHz, and an amplitude in a range of about 50volts to about 10000 volts. The RF voltages can generate an RF electromagnetic field for causing radial confinement of the ions. In some embodiments, DC potential differences between selected rods of the ion trap can be employed for routing ions received via an inlet of the ion trap to one or more desired outlets thereof.

In some embodiments, the mass spectrometer can include a plurality of ion routing devices that are coupled in series such that a first outlet of each ion routing device is configured to direct a first portion of the analyte ions received by that ion routing device into one of the charge reduction devices, and wherein a second outlet of each of at least some of said ion routing devices is configured to supply a second portion of the received analyte ions to the first inlet of an adjacent ion charge reduction device.

In some embodiments, at least a first ion storage device can be operably coupled to at least one of the charge reduction devices to receive the charge reduced ions generated in that charge reduction device. In some such embodiments, at least a second ion routing device is operably coupled to that ion storage device for directing ions stored in said ion storage device to a downstream component of the mass spectrometer.

At least a second ion routing device can be operably coupled to said at least a first ion storage device for directing ions stored in that ion storage device to a downstream component of the mass spectrometer.

In some embodiments, the mass spectrometer can include a plurality of ion storage devices such that each ion storage device is in communication with one of the charge reduction devices to receive at least a portion of the charge reduced ions. A plurality of potential barriers can be employed between each one of the charge reduction devices and a respective ion storage device so as to inhibit the passage of unreacted analyte ions from each of the charge reduction devices to the respective ion storage device and to allow the passage of the charge reduced ions from each of the charge reduction devices to the respective ion storage device.

In some embodiments, the potential barriers can be generated via application of a combination of AC and DC voltages to at least one electrode that is disposed between a charge reduction device and a respective ion storage device.

In some embodiments, at least one charge reduction device can be in communication with at least one adjacent charge reduction device to allow the flow of at least a portion of the reagent ions between the two charge reduction devices. In some embodiments, such flow of the reagent ions can be restricted at least part of the time via application of AC+DC voltages.

A controller in communication with one or more ion routing devices can control the operation of those ion routing device(s), e.g., to direct a first portion of a plurality of analyte ions received by an ion routing device to a first outlet of the ion routing device and to direct a second portion of the analyte ions to a second outlet of the ion routing device.

The mass spectrometer can further include a charge-reducing reagent source (e.g., a PTR reagent source) for providing the plurality of the reagent ions. At least an ion routing device can be in communication with the reagent source to receive, via an inlet thereof, the reagent ions from the reagent source. The ion routing device can include an outlet that is in communication with at least one of the charge reduction devices for delivering at least a portion of the received reagent ions thereto.

In a related aspect, a method of performing mass spectrometry is disclosed, which includes generating a plurality of analyte ions by ionizing at least one analyte in a sample under analysis, using at least one ion-routing device to receive the analyte ions and to distribute the analyte ions among a plurality of charge reduction devices such that each of the charge reduction devices receives a portion of the analyte ions, and subjecting the analyte ions received in the charge reduction devices to a charge reduction reaction so as to reduce a charge state of the analyte ions, thereby generating a plurality of charge reduced ions.

In some embodiments, the analyte ions are distributed among the plurality of charge reduction devices via routing, sequentially, different portions of the analyte ions into different ones of the charge reduction devices.

The charge reduced ions can be released from the charge reduction devices, e.g., for introduction into a plurality of ion storage devices each of which is in communication with a respective one of the charge reduction devices.

The charge reduced ions can then be released from the ion storage devices, e.g., in a sequential manner, to be transferred to a downstream component of the mass spectrometer, e.g., an ion trap. In some such embodiments, the charge reduced ions can be released from an ion storage device to be introduced into an ion dissociation device, such as a collisional ion fragmentation device to generate a plurality of fragment product ions. The product ions generated due to dissociation of the charge-reduced ions can be in turn received by a mass analyzer, which can generate mass detection signals associated with the product ions. A mass analysis module can receive the mass detection signals and process the mass detection signals to generate a mass spectrum of the product ions.

Further understanding of various aspects of the present teachings can be found in the following detailed description in conjunction with the associated drawings, which are described briefly below.

### BRIEF DESCRIPTION OF THE DRAWINGS

FIG. 1A schematically shows a charge reduction system according to an embodiment for use in a mass spectrometer,

FIG. 1B schematically depicts a branched RF ion trap suitable for use in an embodiment of the present teachings as a PTR device,

FIG. 1C shows the branched RF ion trap of FIG. 1B with an AC voltage applied to its electrodes for providing mutual trapping of positively-charged analyte ions and negatively-charged reagent ions or negatively-charged analyte ions and positively-charged reagent ions,

FIGS. 1D and 1E schematically depict using an AC excitation voltage for causing mass selective extraction of charge-reduced ions from a PTR device,

FIGS. 1F and 1G schematically show that the mass selective extraction of charge-reduced ions from a branched RF ion trap can be achieved via application of an AC excitation voltage to exit endcaps of the ion trap,

FIG. 1H shows an example of a potential diagram for mutual trapping of analyte and reagent ions in a PTR cell,

FIG. 1I schematically depicts a potential diagram for loading of positive ions into an ion trap,

FIG. IJ schematically depicts a potential diagram for allowing the flow of positive ions through an ion trap utilized as a PTR cell or ion routing device,

FIG. 2A presents a potential diagram exhibiting potential differences between an ion routing device, a PTR cell receiving ions, an associated ion storage device, and a routing device that receives ions released by the ion storage device,

FIG. 2B presents an example of one system that can generate the potential difference depicted in FIG. 2A between a PTR device and a respective ion storage device,

FIG. 2C schematically depicts the potential difference between a PTR device and a reagent source from which the PTR device receives reagent ions and between adjacent PTR devices,

FIG. 2D shows a plurality of PTR cells, where a cell is coupled directly to a source of negatively-charged reagent ions to receive those ions,

FIG. 2E schematically depicts four PTR cells positioned in tandem with potential barriers between the adjacent cells configured to ensure mutual trapping of reagent and analyte ions in the PTR cell,

FIG. 3A is a top schematic view of a charge reduction system according to an embodiment in which the charge-reduction system exhibits a spatially folded arrangement,

FIG. 3B is a top schematic view of a charge reduction system according to an embodiment, which has a multi-parallel architecture supporting independent analyte ion loading and charge reduction,

FIG. 4A schematically depicts a charge-reduction system according to an embodiment in which a reagent routing device is employed to distribute reagent ions provided by a single reagent source to PTR reactors,

FIG. 4B schematically depicts a partial view of a mass spectrometer in which a parallel PTR system is incorporated

[symbol]

FIG. 5 is a branched RF ion trap that can be configured for use as an ion routing device or a reagent routing device, and

FIG. 6 schematically depicts an example of implementation of a controller suitable for use in the practice of the present teachings.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed an any great detail. One of ordinary skill will recognize that some embodiments of the present disclosure may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and, “substantially, and “substantially equal” refer to variations in a numerical quantity and/or a complete state or condition that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

As used herein, two components are in “communication” with one another or are “coupled” or “operably coupled” to one another when ions, e.g., entrained in a gas flow, can be exchanged between them.

In some embodiments, the present disclosure generally provides a parallel PTR reactor with a common reagent source, which also allows quenching of a PTR reaction upon completion. As discussed in more detail below, such a parallel PTR reactor can include multipole-branched RF ion traps. In some cases, the multipole-branched RF ion traps can have their inputs/outputs sealed using terminating DC or DC/AC voltage caps or they can be connected to each other via interconnect lenses. In embodiments, an additional AC potential applied to such interconnect and endcap lenses can be used to facilitate mutual trapping of both positive and negative ions. In some embodiments, the potentials can be configured so as to allow the passage of reagent ions from one PTR cell to another while inhibiting the leakage of unreacted analyte ions between PTR cells.

As discussed in more detail below, in some cases, different analyte ions may exhibit different PTR rates. As the PTR rate is proportional to the square of an analyte's charge, analytes with different charge states can exhibit different PTR rates. Additionally, the relative density of reagent ions may vary from one PTR cell to another. To address such potential variations, in some embodiments, a parallel PTR reactor design according to the present teachings can include mechanisms for quenching the charge reduction reaction upon completion.

Typically, the m/z or m/z range of ions (and particularly an upper m/z range of ions) trapped in a PTR cell is known. Subsequent to the PTR reaction, the charge reduced ions (herein also referred to as charge-reduced product ions) have a higher m/z ratio than the unreacted analyte ions, and hence can be removed from the charge reaction device while maintaining the remaining unreacted analyte ions within the charge reaction device.

In the following description, various embodiments are described by assuming that the charge-reduction device is a proton transfer reaction device, though other types of devices can also be employed in the practice of the present teachings. For example, rather than utilizing charge reduction devices, a device for ion-ion interaction can be utilized, such as that described in an article titled “Multiply charged cation attachment to facilitate mass measurement in negative-mode native mass spectrometry,” by Pitts-McCoy et al. and published in Anal. Chem. 2022, 94, 4 2220-2226 (https://pubs.acs.org/doi/abs/10.1021/acs analchem. 1c04875) and herein incorporated by reference in its entirety.

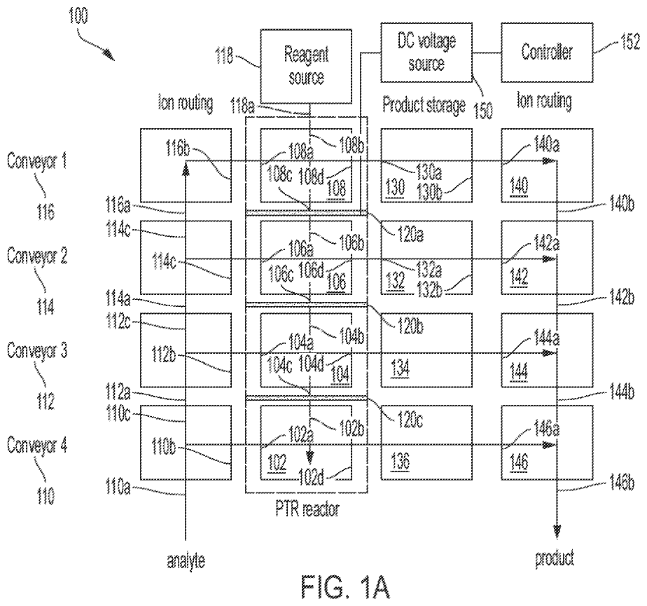

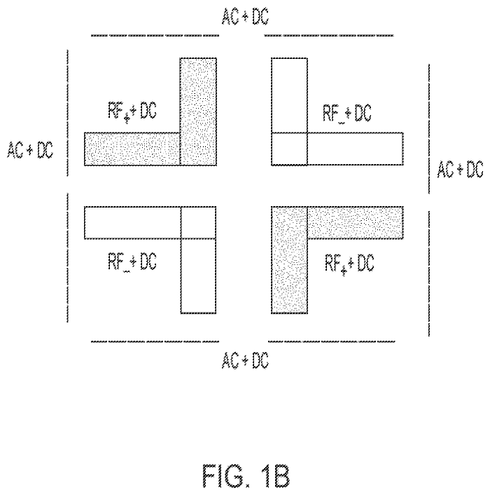

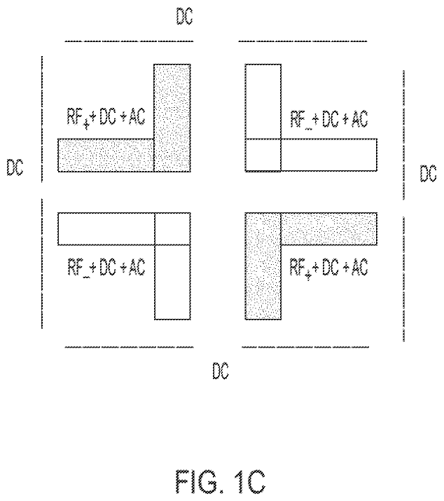

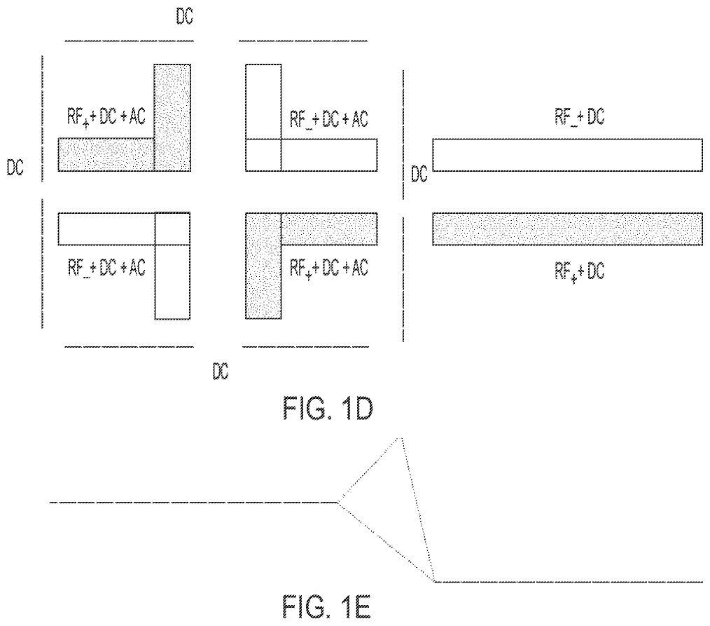

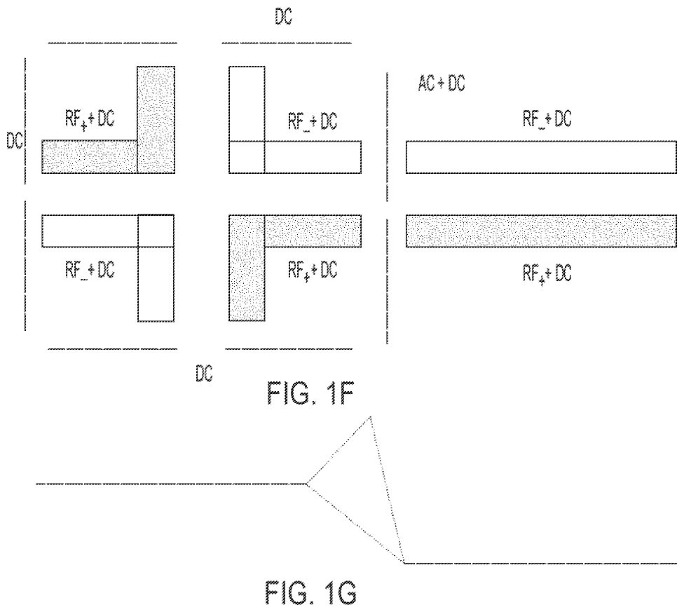

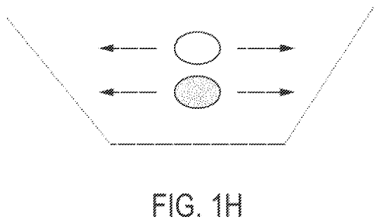

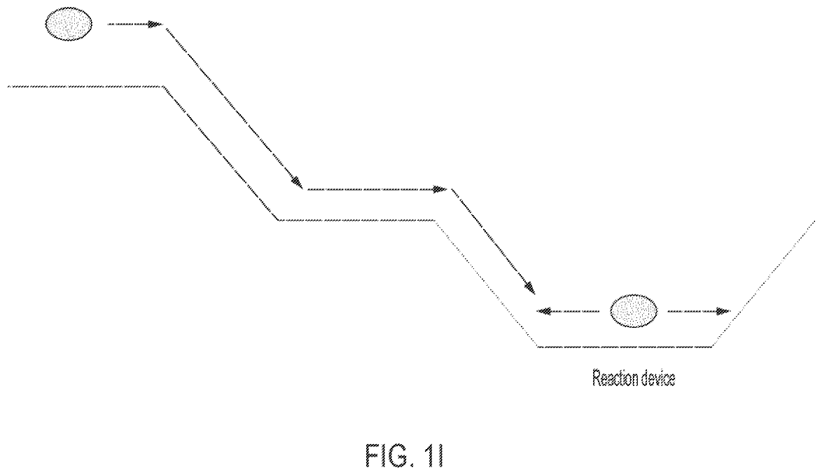

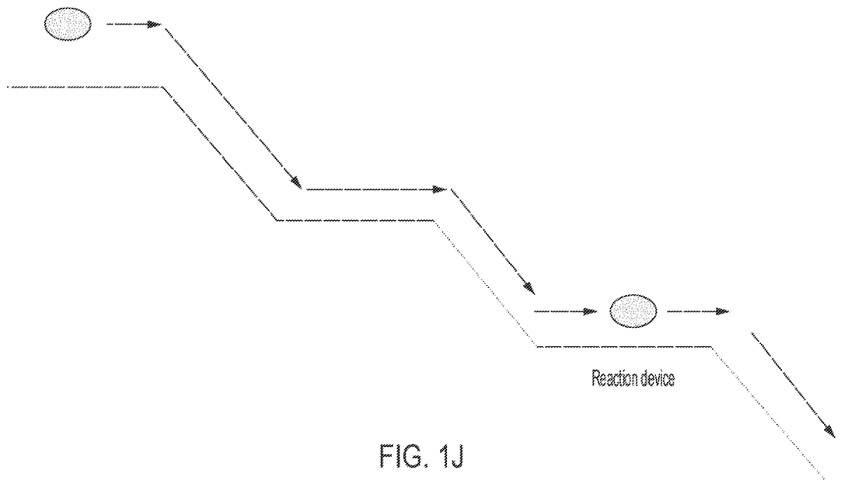

FIG. 1A schematically depicts a charge-reduction system 100 according to an embodiment of the present teachings suitable for use in a mass spectrometer. The system 100 includes a plurality of proton transfer reaction (PTR) devices 102, 104, 106, and 108 (herein also referred to as a PTR cell) that can receive different portions of a plurality of analyte ions, e.g., in sequence, in a manner discussed below.

The charge-reduction system 100 further includes a plurality of ion-routing devices 110, 112, 114, and 116 for distributing ions generated by an ion source (not shown in the figure) among the PTR devices. In this embodiment, each of the ion-routing devices is in the form of a branched radio frequency (RF) ion trap, which can receive ions via an inlet thereof and direct at least a portion of the received ions via an outlet to one of the charge reduction devices. In particular, the ion-routing device 110 has an inlet 110a for receiving a plurality of ions and an outlet 110b that is in communication with an inlet 102a of the charge reduction device 102 and through which a portion of the received ions is transferred into the charge reduction device 102. The ion-routing device 102 further includes another outlet 110c that is in communication with an inlet 112a of the adjacent ion-routing device 112 such that another portion of the ions received by the ion-routing device 110 is routed into the ion routing device 112.

Similar to the ion-routing device 110, the ion-routing device 112 includes two outlets 112b and 112c, where the outlet 112b is in communication with an inlet 104a of the charge-reduction device 104 through which a portion of the ions received by the ion-routing device 112 is directed into the charge-reduction device 104 and the outlet 112c is in communication with an inlet 114a of a subsequent ion-routing device 114 through which another portion of the ions received by the ion-routing device 112 is directed to the subsequent ion-routing device 114. The ion-routing device 114 includes an outlet 114b that is in communication with an inlet 106a of the charge-reduction device 106 and an outlet 114c that is in communication with an inlet 116a of the subsequent ion-routing device 116.

As the ion-routing device 116 is the final ion-routing device in the set of serially-connected ion-routing devices, it includes only one outlet 116b through which the ions (or at least a portion thereof) received via the previous ion-routing device 114 is directed to the charge-reduction device 108 via an inlet 108a thereof.

With continued reference to FIG. 1A, a plurality of electrodes 120a, 120b, and 120c are disposed between pairs of adjacent PTR devices. An adjustable DC voltage source 150 operating under control of a controller 152 can apply voltages to these electrodes so as to generate DC potential barriers for inhibiting the leakage of the analyte ions from one charge-reduction device to an adjacent charge-reduction device (although in FIG. 1A, the DC voltage source is depicted as being electrically connected to only one of the electrodes, the DC voltage source 150 (or another DC voltage source) can be electrically connected to the other electrodes for application of DC voltages thereto). The electrodes can include openings through which reagent ions for reacting with the analyte ions can pass to reach an adjacent PTR device, as discussed in more detail below.

More specifically, in this embodiment, a reagent source 118 can provide a reagent for reacting with the analyte ions so as to reduce their charge state, e.g., by one charge unit. The reagent source 118 is in communication via an outlet 118a thereof with another inlet 108b of the PTR device 108 to deliver the reagent to that PTR device. The PTR device 108 includes an outlet 108c through which at least a portion of the reagent ions can exit the PTR device 108 to reach the adjacent PTR device 106 via an inlet 106b thereof. An example of a reagent suitable for use in a PTR device in the practice of the present teachings for reducing the charge state of positively charged analyte ions is perfluoroperhydrophenanthrene. For negatively charged analytes, in some embodiments, positively charged xenon ions can be utilized.

Each of the electrodes 120a, 120b, and 120c includes an opening through which the reagent ions can pass to reach an adjacent charge reduction device. As the charge state of the reagent ions is opposite to the charge state of the analyte ions, the electrodes 120a, 120b, and 120c with the appropriate DC voltages applied thereto can inhibit the passage of the analyte ions but allow the passage of the oppositely charged reagent ions. For example, for positively charged analyte ions, the DC barrier voltages applied to the electrodes 120a, 120b, and 120c can have a positive polarity while for negatively charged analyte ions the DC barrier voltage applied to those electrodes can have a negative polarity. By way of example, the DC barrier voltage can have an amplitude in a range of about 1 volt to about 10 volts relative to the PTR cell, though other amplitudes can also be employed, e.g., depending on a particular application including the type of the analyte and/or the reagent ions.

With continued reference to FIG. 1A, a portion of the reagent ions pass through an outlet 106c of the charge reduction device 106 to reach, via passage through an opening in the electrode 120b, the charge reduction device 104. Similarly, a portion of the reagent ions pass through an outlet 104c of the PTR device 104 to reach, via passage through an opening in the electrode 120c, the PTR device 102. In this manner, the reagent ions from a single source (the reagent source 118 in this embodiment) can be distributed among the PTR devices for reacting with the analyte ions received by the PTR devices so as to generate a plurality of charge reduced ions.

In this embodiment, each of the PTR cells is operably coupled to an ion storage device with potential barriers generated between each of the PTR devices and a respective ion storage device (e.g., via application of AC and/or DC voltages to an electrode positioned between each PTR device and a respective ion storage device). Such potential barriers can be configured to inhibit the passage of untreated analyte ions from a PTR device to a corresponding ion storage device while allowing the charge reduced ions (i.e., product ions generated via the charge-reduction reactions) to exit the respective ion storage device. By way of example, in some other embodiments the AC voltage is applied to a set of electrodes forming the branched RF trap instead of being applied to the lens between the branched RF traps so that the branched RF trap has DC+RF+AC potentials applied to its electrodes, wherein RF potential is set up for ion confinement in radial direction and AC potential forms a barrier between the branched RF trap and each electrode forming a passageway or capping the RF trap along the ion movement axis.

By way of illustration, FIG. 1B schematically depicts a branched RF ion trap 160 that can be utilized in the practice of certain embodiments as a PTR device. The branched RF ion trap 160 includes two sets of L-shaped electrodes 160a/160b that are axially separated from one another. The ion trap 160 further includes end cap lenses 160c/160d/160e/160f that can allow mutual trapping of analyte and reagent ions. By way of illustration, FIG. 1B shows an example of application of RF and DC voltages to the L-shaped electrodes as well as AC+DC voltages applied to the endcap/interquad lenses for providing mutual trapping of the analyte and the reagent ions within the PTR device.

FIG. 1C shows the above branched RF ion trap 160 in which an AC voltage is applied to the L-shaped electrodes rather than the endcap lenses for providing mutual trapping of the analyte and the reagent ions.

By way of illustration, FIG. 1H shows an example of a potential diagram for mutual trapping of the analyte and the reagent ions. The dashed lines indicate an AC+DC potential at the two ends of each passageway of the ion trap. Since the AC barrier generated by the potential is the same for both ion charge polarities, such an arrangement can enable mutual trapping of both the analyte and the reagent ions (filled circles represent positive ions, empty circles represent negative ions). Generally, the ion trap is filled with a background gas (herein also referred to as a bath gas) at a pressure, for example, in a range of about 1 to about 10 m Torr, for causing collisional cooling of the ions and reduce their kinetic energy so as to allow their entrapment within the ion guide and facilitate ion-ion interaction.

The loading of ions into the ion trap can also be achieved via establishment of appropriate potentials in a manner known in the art as informed by the present teachings. By way of example, FIG. 1I schematically depicts a potential diagram for loading of positive ions into the trap. Each line indicates a DC or a combination of DC+AC potential for this ion. As shown in this figure, the potentials are arranged so as to cause the ions to move down the potential ramps into the ion trap and then be trapped therein. A background buffer gas is employed to cause collisional cooling of the ions so as to reduce their kinetic energy in order to allow their entrapment in the ion trap.

FIG. 1J schematically depicts a potential diagram for allowing the flow of positive ions through a PTR device or an ion routing device. The potential diagram shows a plurality of plateau regions connected by downward-sloping potential ramps along which the positive ions can be guided into the PTR device (herein also referred to as the reaction device) and out of the PTR device.

As discussed in more detail below, the charge-reduced ions generated in a PTR device can be extracted from the device for introduction to downstream components of the mass spectrometer. By way of example, FIG. 1D and FIG. 1E schematically depict using an AC barrier voltage facilitating the mass dependent extraction of those charge-reduced ions above predefined m/z range from the PTR device. In this example, the extracted charge-reduced ions are received by an ion guide or ion fragmentation device, such as collision cell.

By way of another example, FIGS. 1F and 1G schematically show that the mass dependent extraction of the charge-reduced ions from the branched RF ion trap can be achieved via application of a combination of DC+AC voltages, in such a manner that ions above predefined m/z are not trapped in the cell.

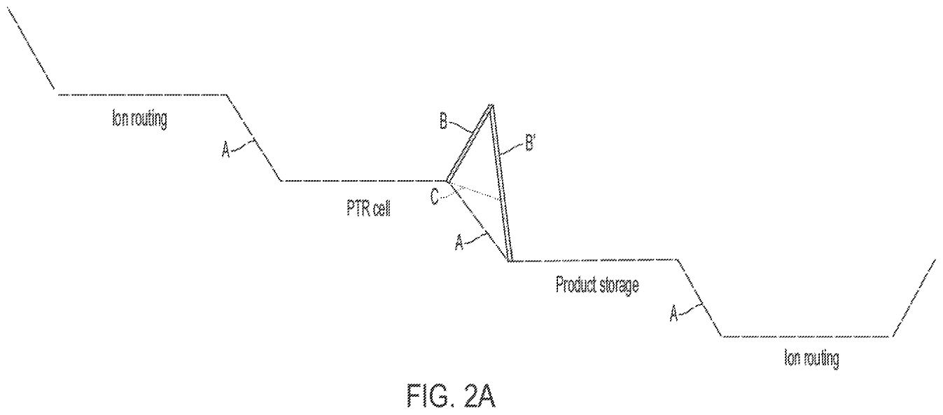

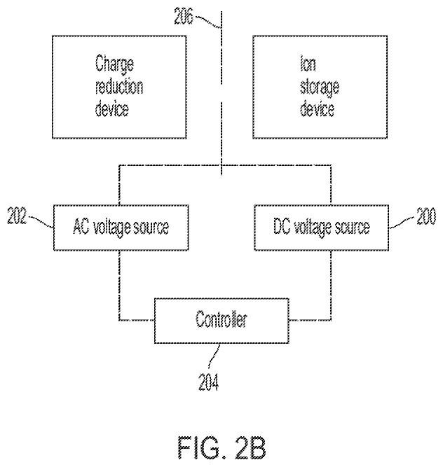

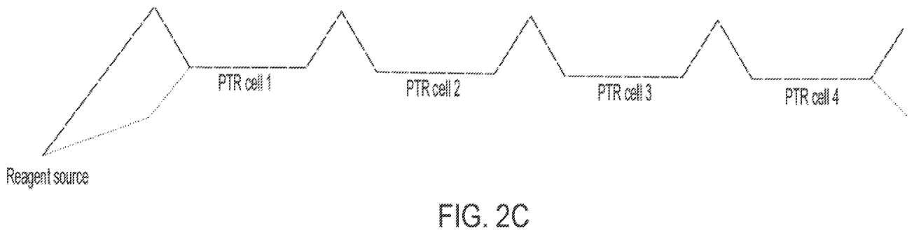

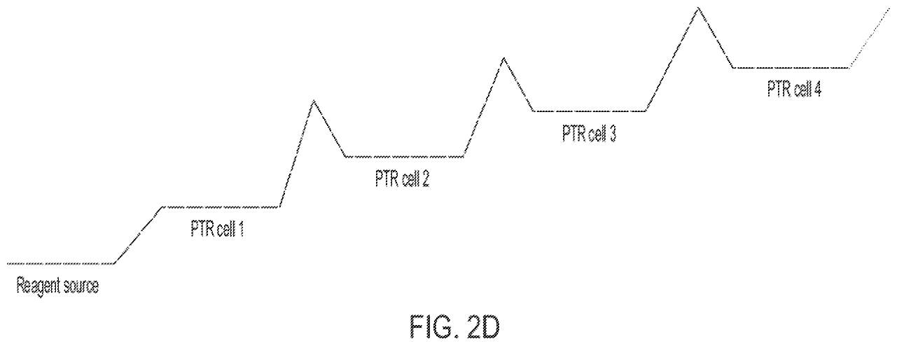

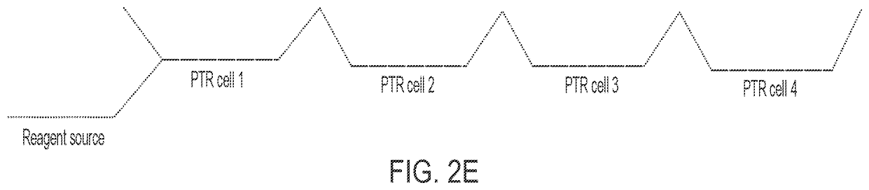

FIG. 2A presents a potential diagram illustrating examples of a potential difference between an ion routing device and a PTR cell receiving ions from that ion routing device as well as the potential differences between the PTR cell and a respective ion storage device and between the ion storage device and another ion routing device that receives ions from the ion storage device and directs the received ions to a downstream ion routing device associated with another storage device or to another downstream component of the mass spectrometer, e.g., a mass analyzer. The thin solid line (A) in the potential diagram represents relative DC potentials. The thick solid lines (B and B′) represent the superimposed AC pseudopotential plus the DC potential for unreacted analyte ions, and the dashed line (C) represents superimposed AC and DC potentials for the charge-reduced ions (i.e., ions that have undergone charge reduction via reaction with the reagent ions) and hence have a higher m/z ratio relative to the unreacted analyte ions. As noted above, the potential barrier between a PTR cell and an ion storage device allows the transfer of the charge-reduced ions from the PTR cell to the ion storage device while inhibiting the transfer of unreacted analyte ions from the PTR cell to the ion storage device. In this manner, the charge-reduction reaction can be quenched, i.e., the charge-reduced ions are prevented from undergoing additional charge reduction reactions. The AC potential barrier can be approximated as a pseudopotential barrier, where the pseudopotential can be about few volts, e.g., in a range of about 0 volt to about 10 volts.

In some embodiments, AC and DC voltages can be applied to electrodes positioned between the charge reduction devices and the ion storage devices to generate the potential barrier depicted in FIG. 2A. By way of example, with reference to FIG. 2B, a DC voltage source 200 and an AC voltage source 202 operating under control of a controller 204 can apply the required AC and DC voltages to an electrode 206 positioned between one of the charge reduction devices and a respective ion storage device to generate a desired potential barrier between the charge reduction device and the ion storage device.

FIG. 2C schematically depicts the potential difference between a PTR device and a reagent source from which the PTR device receives reagent ions and between adjacent PTR devices, where the potential differences between adjacent PTR devices can be configured to allow passage of charge-reducing reagents from one PTR device to an adjacent PTR device while inhibiting the passage of unreacted analyte ions between those devices, as discussed in more detail below. The solid line indicates an applied DC potential and the dashed line indicates an AC pseudo potential superimposed on a DC potential for directing the negative reagent ions from the reagent source to the PTR devices.

FIG. 2D shows a plurality of PTR cells (herein referred to cell 1, cell 2, cell 3, and cell 4), where cell 1 is coupled directly to a source of negatively-charged reagent ions to receive those ions. Further, FIG. 2D shows schematically a potential difference between the reagent source and PTR cell 1 that allows the flow of the negatively-charged reagent ions from the reagent source into PTR cell 1 as well as potential differences between adjacent PTR cells that allow the flow of the negatively-charged reagent ions between adjacent PTR cells while trapping the positively-charged analyte ions within the cells. In this example, no AC field is applied along the shown axis as there is no need for mutual trapping of both the positively-charged analyte ions and the negatively-charged reagent ions. An AC field can nonetheless be applied to different outlets of the PTR cells to generate a pseudopotential barrier for preventing the reagent ions from escaping through those outlets and also such an AC field can be utilized for causing mass selective extraction of charge-reduced ions from the PTR cells.

FIG. 2E schematically depicts four PTR cells (cell 1, cell 2, cell 3, and cell 4) positioned in tandem with potential barriers between the adjacent cells configured to ensure mutual trapping of reagent and analyte ions in the PTR cell. The potential barrier between the reagent source and PTR cell 1 allows the transfer of the reagent ions from the reagent source to PTR cell 1. In some cases, the ion loading and analyte-reagent ion reaction can be achieved in parallel at least with respect to certain of the PTR cells. Alternatively, the reagent ions can be preloaded into the reaction cells (e.g., via sequential loading) and the analyte ions can be loaded into the PTR cells using the loading arrangement discussed further below in connection with FIG. 1L.

In this embodiment, the charge-reduction devices 108, 106, 104, and 102 are operably coupled to the ion storage devices (e.g., ion traps) 130, 132, 134, and 136, respectively, to transfer the charge reduced ions thereto. More specifically, in this embodiment, the charge reduced ions exit the charge-reduction devices 108, 106, 104, and 102 via outlets 108d, 106d, 104d, and 102d, respectively, to reach the ion storage devices via their inlets 130a, 132a, 134a, and 136a. The transfer of the charge reduced ions from the ion storage devices allows advantageously quenching the charge reduction reaction with respect to the charge reduced ions that have been transferred from a charge reduction device to a respective ion storage device.

The ion storage devices 130, 132, 134, and 136 are in communication with another set of ion routing devices 140, 142, 144, and 146, respectively. The charge-reduced ions released from each of the ion storage devices are routed via a respective ion routing device to downstream components of the mass spectrometer. A DC potential barrier provided between each of the ion storage devices and a respective ion routing device can be gated to release ions stored in the ion storage device so as to introduce them into the ion routing device. Such a DC potential barrier can be implemented, for example, via application of a DC voltage to an electrode disposed between an ion storage device and a respective ion routing device, where the electrode includes an opening through which the ions can pass.

More specifically, the stored charge-reduced product ions can exit the ion storage devices 130, 132, 134, and 136 via the respective outlets 130b, 132b, 134b, and 136b to be received via the inlets 140a, 142a, 144a, and 146a of the storage devices.

In this embodiment, the ion-routing devices 140, 142, 144, 146 are in communication with one another such that the ions received by an upstream ion-routing device can pass through one or more downstream ion-routing device(s) to reach a downstream component of the mass spectrometer, e.g., an ion guide or a mass analyzer.

The outlet 140b of the ion routing device 140 is in communication with the inlet 142a of the ion routing device 142, the outlet 142b of the ion routing device 142 is in communication with the inlet 144a of the ion routing device 144, and the outlet 144b of the ion routing device 144 is in communication with the inlet 146a of the ion routing device 146. Finally, the outlet 146b of the ion routing device 146 is in communication with a downstream component of the mass spectrometer, e.g., a mass analyzer.

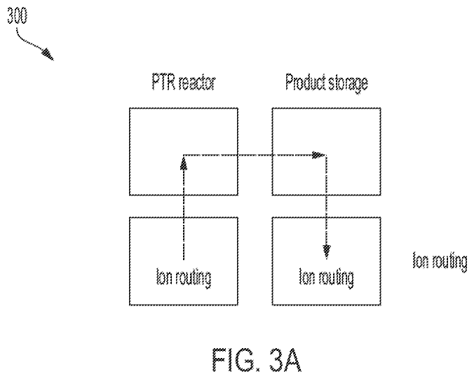

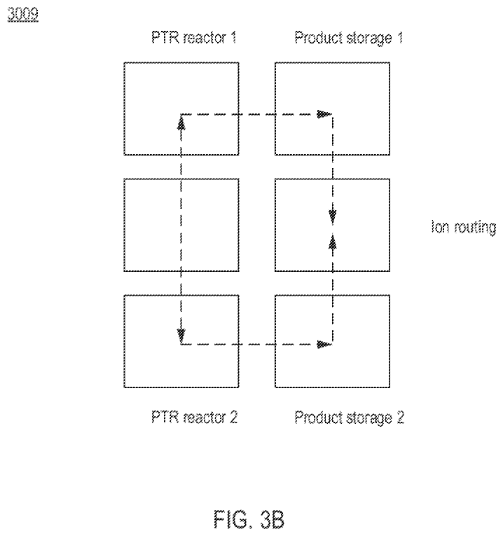

A charge-reduction system according to the present teachings can be implemented using a variety of different spatial arrangements. By way of example, in some embodiments, the spatial arrangement can be selected to minimize the footprint of the system. By way of example, FIG. 3A is a top schematic view of a charge reduction system 300 according to an embodiment of the present teachings, which has a spatially folded configuration.

In some embodiments, a charge reduction system according to the present teachings can include multiple charge reduction subsystems, where each subsystem is configured in a manner discussed above to include a plurality of charge reduction devices (e.g., PTR cells) that can be sequentially loaded with analyte ions. In some such embodiments, the charge-reduction subsystems operate in parallel and can be loaded with analyte ions independent of one another.

FIG. 3B is a schematic top view of an example of such a charge reduction system 300a exhibiting a multi-parallel architecture supporting independent loading of analyte ions and their reaction with charge-reducing reagent ions.

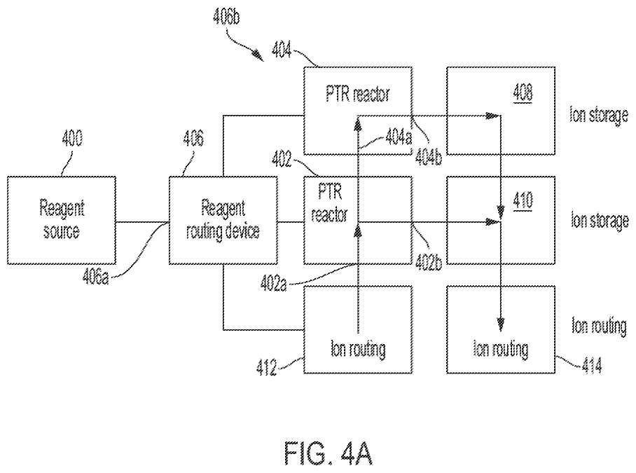

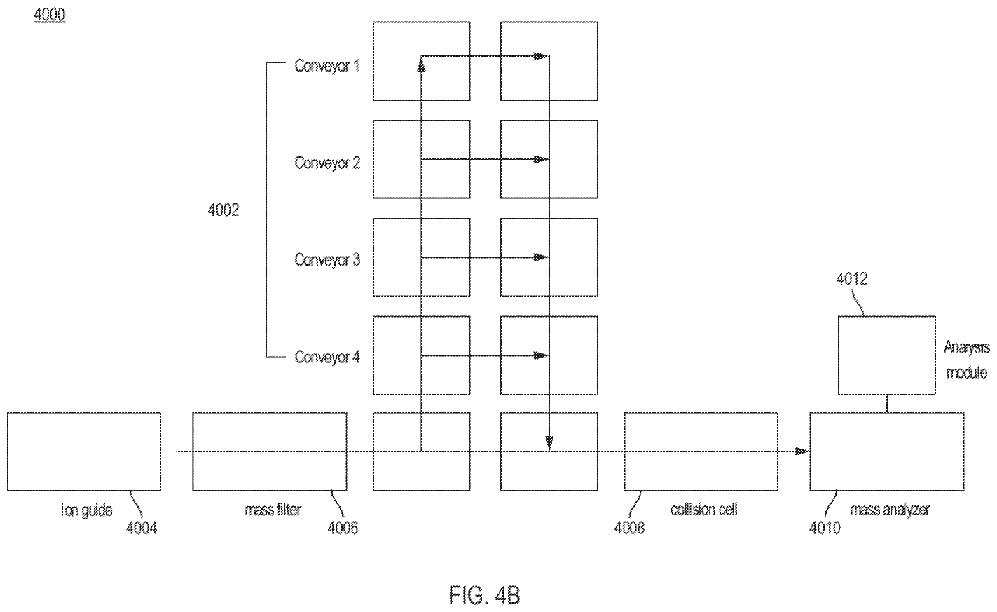

In some embodiments, the reagent ions for reducing the charge state of a plurality of analyte ions can be supplied by a single reagent source and can be distributed to a plurality of charge reduction devices via one or more reagent routing devices. By way of example, FIG. 4A schematically depicts an example of such an embodiment in which a single reagent source 400 can provide reagent ions to two PTR devices 402 and 404, via a reagent routing deice 406. By way of example, the reagent routing device can be implemented as a branched RF ion guide, similar to those described above, and can include an inlet 406a that can receive reagent ions (or precursors thereof) from the reagent source 400 and two outlets 406b and 406c through each of which a portion of the reagent ions can exit the reagent routing device. In this example, the reagent ions exiting the reagent routing device via the outlet 406b are received by the charge reduction device 402 and the reagent ions exiting the reagent routing device via the outlet 406c are received by the PTR device 404.

The PTR reactors 402 and 404 are operably coupled to ion storage devices 408/410, respectively, to transfer the generated charge-reduced ions thereto. More specifically, in this embodiment, an ion routing device 412 is employed for transferring a plurality of analyte ions to the PTR reactor 402 via an inlet port 402a thereof. A portion of the analyte ions received by the PTR reactor 402 exit the PTR reactor 402 via an outlet 402c thereof to be received by the PTR reactor 404 via its inlet 404a and a portion of the analyte ions undergo a reduction in their charge state to generate a plurality of charge-reduced ions that exit the PTR reactor 402 via an outlet 402b thereof to be received by the ion storage device 410. The ions received by the PTR reactor 404, in turn, undergo a reduction in their charge state via reaction with the reagent ions to generate charge-reduced ions, which are transferred to the ion storage device 408.

The charge-reduced ions can be released from the ion storage devices in a manner discussed above and the released charge-reduced ions can be routed via an ion routing device 414 to a downstream component of the mass spectrometer, e.g., to a collision cell in which the charge-reduced ions can undergo fragmentation.

FIG. 4B schematically depicts a partial view of a mass spectrometer 4000 in which a parallel PTR system 4002 according to an embodiment of the present teachings is incorporated. The mass spectrometer 4000 includes an ion guide 4004 that receives a plurality of ions from an upstream ion source (not shown) and generates an ion beam that is received by a mass filter 4006 that is positioned downstream of the ion guide 4004. The mass filter can be implemented, for example, using a set of quadrupole rods to which RF and DC voltages can be applied for selecting a precursor ion of interest having a target m/z ratio. The precursor ions can, in turn, be received by the PTR system 4002 to undergo charge reduction. A downstream collision cell 4008 can receive the charge reduced ions and subject those ions to collisional fragmentation, thereby producing a plurality of fragment product ions. The fragment product ions can be mass analyzed by a downstream mass analyzer 4010, e.g., a quadrupole or a time-of-flight (ToF) mass analyzer, which can generate mass detection signals that are received and processed by an analysis module 4012 in a manner known in the art as informed by the present teachings.

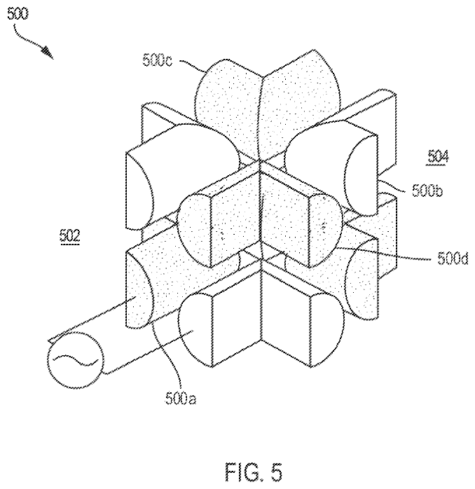

As discussed above, in some embodiments, an ion routing device suitable for use in the practice of the present teachings can be implemented as a branched RF ion trap. By way of example, FIG. 5 schematically depicts such a branched RF ion trap 500 that includes two sets of L-shaped rods 502/504, where each set includes four rods that are arranged according to a quadrupole configuration. The two rod sets are axially separated from one another to form a longitudinal passage that extends from an inlet 500a to an outlet 500b, and a transverse channel that provides two transversely opposed outlets 500c/500d.

A controller suitable for use in the practice of the present teachings can be implemented using techniques known in the art as informed by the present teachings.

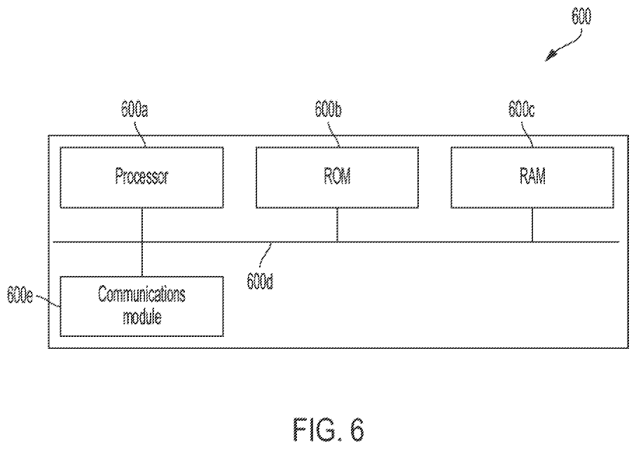

As noted above, a controller suitable for use in the practice of the present teachings, such as the above controller 152 can be implemented in hardware, firmware and/or software in a manner known in the art as informed by the present teachings. By way of example, FIG. 6 schematically depicts an example of such an implementation of the controller.

FIG. 6 schematically depicts an example of an implementation of such a controller 600, which includes a processor 600a (e.g., a microprocessor), at least one permanent memory module 600b (e.g., ROM), at least one transient memory module (e.g., RAM) 600c, and a communication bus 600d, among other elements generally known in the art.

The communication bus 600d allows communication between the processor and various other components of the controller. In this example, the controller 600 can further include a communications module 600e that is configured to allow sending and receiving signals.

Instructions for use by the controller 600 for analyzing the mass spectral data and generating a mass spectrum of the product ions can be stored in the permanent memory 600b and can be transferred during runtime into the transient memory module 600c for execution. Similarly, the instructions for use by the above controller 204, e.g., for controlling the operation of the RF and/or DC voltage sources, can be stored in the permanent memory module 600b and be transferred into the transient memory for execution during runtime.

Those having ordinary skill will appreciate that various changes may be made to the above embodiments without departing from the scope of the invention.

The above detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments, and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

What is claimed is:

1. A mass spectrometer, comprising:
an ion source configured to receive a sample and ionize at least one analyte in the sample to generate a plurality of analyte ions,
at least a first ion routing device having a first inlet for receiving at least a portion of the plurality of the analyte ions and at least a first and a second outlet through which a first and a second portion of the received analyte ions can exit the ion-routing device, respectively, and
at least two charge reduction devices one of which is coupled via a first inlet thereof to said first outlet and the other is coupled via an inlet thereof to the second outlet of the ion routing device to receive said first and second portions of the ions exiting the ion routing device.

2. The mass spectrometer of claim 1, wherein each of said charge reduction devices comprises a second inlet for receiving a plurality of reagent ions for reacting with the analyte ions received by that charge reduction device to reduce a charge state of said analyte ions. thereby generating a plurality of charge reduced ions.

3. The mass spectrometer of claim 1, wherein said charge reduction devices comprise a proton transfer reaction (PTR) device.

4. The mass spectrometer of claim 1, wherein said at least a first ion routing device comprises a branched ion trap.

5. The mass spectrometer of claim 4, wherein said branched ion trap comprises a radio frequency (RF) ion trap.

6. The mass spectrometer of claim 5, further comprising at least one RF voltage source for applying one or more RF voltages to said RF ion trap.

7. The mass spectrometer of claim 1, wherein said at least a first ion routing device comprises a plurality of ion routing devices coupled in series such that a first outlet of each ion routing device is configured to direct a first portion of the analyte ions received by that ion routing device into one of said charge reduction devices, and wherein a second outlet of at least some of said ion routing devices is configured to supply a second portion of the received analyte ions to the first inlet of an adjacent charge reduction device.

8. The mass spectrometer of claim 2, further comprising at least a first ion storage device fluidically coupled to at least one of said charge reduction devices to receive the charge reduced ions generated in that charge reduction device.

9. The mass spectrometer of claim 8, further comprising at least a second ion routing device operably coupled to said at least a first ion storage device for directing ions stored in said ion storage device to a downstream component of said mass spectrometer.

10. The mass spectrometer of claim 2, further comprising a plurality of ion storage devices each in fluid communication with one of said charge reduction devices to receive at least a portion of the charge reduced ions.

11. The mass spectrometer of claim 10, further comprising a plurality of barrier potentials each separating one of the charge reduction devices from a respective ion storage device, wherein each of said barrier potentials is configured to inhibit passage of unreacted analyte ions from each of the charge reduction devices to the respective ion storage device and to allow passage of the charge reduced ions from each of the charge reduction devices to the respective ion storage device.

12. The mass spectrometer of claim 11, wherein said barrier potentials comprise a combined DC and AC potentials.

13. The mass spectrometer of claim 2, wherein said at least two charge reduction devices are in communication with one another such that said reagent ions can flow from one of said charge reduction devices to the other.

14. The mass spectrometer of claim 1, further comprising a controller in communication with said at least a first ion routing device for controlling the at least a first ion routing device so as to direct said first and second ion portions to said first and second outlets, respectively.

15. The mass spectrometer of claim 2, further comprising a reagent source for providing the plurality of the reagent ions.

16. The mass spectrometer of claim 15, further comprising at least a second ion routing device in communication with said reagent source, said second ion routing device having an inlet for receiving the reagent ions from said reagent source and having at least one outlet in fluid communication with at least one of said charge reduction devices for delivering said reagent ions thereto.

17. A method of performing mass spectrometry, comprising:
generating a plurality of analyte ions by ionizing at least one analyte in a sample under analysis.
using at least one ion-routing device to receive said analyte ions and to distribute said analyte ions among a plurality of charge reduction devices such that each of the charge reduction devices receives a portion of the analyte ions, and
subjecting the analyte ions received in said charge reduction devices to a charge reduction reaction so as to reduce a charge state of said analyte ions, thereby generating a plurality of charge reduced ions.

18. The method of claim 17, wherein said step of distributing said analyte ions among said plurality of charge reduction devices comprises routing, sequentially, different portions of said analyte ions into different ones of said charge reduction devices.

19. The method of claim 17, further comprising releasing said charge reduced ions from said charge reduction devices and optionally directing the released charge reduced ions from each of the charge reduction devices to a respective one of a plurality of ion storage devices.

20. The method of claim 19, further comprising releasing the charge reduced ions from each of the ion storage devices and directing the charge reduced ions released from each of the ion storage devices to a mass analyzer of the mass spectrometer.
